(19) United States
(12) Patent Application Publication
(10) Pub. No.: US 2001/0047743 A1
(43) Pub. Date: Dec. 6, 2001

(54) Multi-purpose enclosure for security devices

(76) Inventors: Elie-Jean Raad, New Westminster (CA); William Fenton, Surrey (CA)

Correspondence Address: Hall, Priddy, Myers & Vande Sande, Suite 200, 10220 River Road, Potomac, MD, 20854, US

(21) Appl. No.: 09/805,365

(22) Filed: Mar. 14, 2001

(30) Foreign Application Priority Data
Mar. 14, 2000 (CA) 2,300,605

(51) Int. Cl. E05G 1/00

(52) U.S. Cl. 109/50

(57) ABSTRACT

The present invention relates to a multi-purpose security enclosure for security devices. The multi-purpose security enclosure is comprised of a mounting base, a protective cover and a securement means. The protective cover is rotatable about 360°.

### FIELD OF THE INVENTION

The present invention relates to the field of security monitoring. Specifically, the present invention is a multi-purpose security enclosure for security devices such as illuminators and security video cameras.

### BACKGROUND OF THE INVENTION

Video surveillance systems are part of a continually evolving field of technology wherein many different types of security devices, such as video cameras and illuminators, have been developed. At present most video surveillance systems consist of a video camera and an illuminator (infrared, visible or any other such light spectrum). The video camera consists of a protective enclosure which contains the electrical components of the camera, and a lens through which the camera is operative to receive, capture, record and store, and optionally transmit, video images of a particular location or scene.

In such traditional systems, the illuminator is operative to generate light for the illumination of the location or scene during times of low ambient light or contrast. The illuminator also consists of a protective enclosure that covers the electrical components responsible for generating light. When operative, the light passes through the protective cover to illuminate the scene for higher contrast and therefore visibility for the surveillance system. The electrical components of an illuminator usually contain a power source, one or more light emitting components, such as LEDs, or light bulb, which generate light in a particular spectrum range.

Security devices, that is to say video cameras and illuminators, are typically mounted on a wall, ceiling or side of building to provide for the monitoring of either an internal or external area of interest. Depending on the particular security application, design considerations for illuminators and video cameras are often substantially different. For example, illuminators used to light external scenes are often large and manufactured as a floodlight assembly. Whereas, illuminators used to light internal scenes are often much smaller and compact, such as those used for passive infrared intruder detection. The design parameters for video cameras also vary radically, depending on the application. In general, though, both video cameras and illuminators are designed independently of each other, although both devices similarly require a protective enclosure to contain electrical components, and a lens through which either to receive or transmit light. As manufacturing design is costly, it is desirable to develop a multi-purpose security enclosure for use in surveillance monitoring to accommodate either a video camera or illuminator interchangeably.

As both video cameras and illuminators are used to capture an area of particular interest, these devices are often fixed in their direction according to its position of attachment on a wall or ceiling. In particular this direction is determined by the position of either the video camera or illuminator on the mounting surface and the direction to which the lens is facing and through which light is either received or emitted. Often, due to limited mounting possibilities and limited angles of adjustment for positioning of these types of devices, it is difficult to ensure illumination or capture of a particular segment of the scene. As a result there may be dead zones where the monitoring device cannot be positioned to either illuminate or to capture. Therefore, a solution to the aforementioned problem is required. In particular it is desirable to have a multi-purpose enclosure suitable for use by both video cameras and IR illuminators whose lens can be adjusted and positioned independently of the base mounting housing.

Illuminators and video surveillance cameras are well known in the art. However, there are few patents that specifically address the aforementioned problem of providing a lens component that can be adjusted independently of the housing. U.S. Pat. No. 5,886,821 (Sohn) mentions the need to create a small-scale motion detector with a wide angular range. U.S. Pat. No. 5,969,754 (Zeman) uses an IR illuminator to enhance the images captured within a video camera. Both patents fail to address the problem of providing an IR illuminator whose lens can be adjusted independently of the housing. U.S. Pat. No. Des. 334,541 (Schwartz) provides an ornamental design for a passive infrared detector mounted in a housing with a rotational sleeve, however the housing of the device is large and rather bulky.

It is the overall object of the present invention to provide a multi-purpose security enclosure for security devices whose protective cover can be adjusted independently of the housing to provide a maximum possible field of view or illumination of a particular scene.

It is a further object of the present invention to provide a multi-purpose security enclosure comprised of two parts, namely a base and a protective cover which freely rotates around the base to provide a maximum field of view or illumination, facilitating the easy adjustment of the transmitting or receiving components via rotation of the cover around a base.

### SUMMARY OF THE INVENTION

According to the invention, there is provided a multi-purpose security enclosure consisting of a mounting base, a protective cover and a securement means.

The mounting base may be mounted to a ceiling, wall or any other location where a security device is to be located.

The protective cover is rotational secured to the mounting base by the securement means, allowing the protective cover to rotate through 360°. The protective cover is angularly secured to the mounting base such that the plane of engagement between the mounting base and the protective cover is at an acute angle to the bottom plane of the mounting base. The entire protective cover, or a portion thereof, allows light to be received, transmitted, or both. Security devices mounted within the multi-purpose security enclosure are secured to the interior of the protective cover in order to maintain a fixed positional relationship with the top portion of the protective cover.

The securement means may include an axial fastener that passes through the top portion of the protective cover to engage the mounting base. The axial fastener is positioned such that it lies along the axis of rotation of the protective cover.

Alternatively, the securement means may include a perimeter bracket engaging the protective cover and the mounting base around the perimeter of the plane of engagement.

The rotational, angular engagement of the mounting base and the protective cover allows the direction of view of a security device mounted within the protective cover to be adjusted from a line perpendicular to the bottom plane of the mounting base to a line perpendicular to the plane of engagement between the protective cover and the mounting base.

Other objects and advantages of the invention will become clear from the following detailed description of the preferred embodiment, which is presented by way of illustration only and without limiting the scope of the invention to the details thereof.

### BRIEF DESCRIPTION OF THE DRAWINGS

Many objects and advantages of the present invention will be apparent to those of ordinary skill in the art when this specification is read in conjunction with the attached drawings wherein like reference numerals are applied to like elements and wherein:

FIG. 1 is a side view of a multi-purpose security enclosure of this invention having a direction of view of a security device perpendicular to the bottom plane of the mounting base;

FIG. 2 is a side view of a multi-purpose security enclosure of this invention having a direction of view of a security device perpendicular to the plane of engagement of the protective cover and the mounting base;

FIG. 3 is a perspective view of a multi-purpose security enclosure of this invention having a direction of view of a security device perpendicular to the bottom plane of the mounting base;

FIG. 4 is a perspective view of a multi-purpose security enclosure of this invention having a direction of view of a security device perpendicular to the plane of engagement of the protective cover and the mounting base;

FIG. 5 is a top view of a multi-purpose security enclosure of this invention showing an axial fastener as a securement means;

FIG. 6 is a cutaway side view of a multi-purpose security enclosure of this invention showing an axial fastener as a securement means;

FIG. 7 is a perspective view of a multi-purpose security enclosure of this invention showing a perimeter bracket as a securement means; and

FIG. 8 is a cutaway side view of a multi-purpose security enclosure of this invention showing a perimeter bracket as a securement means.

### DETAILED DESCRIPTION WITH REFERENCE TO THE DRAWINGS

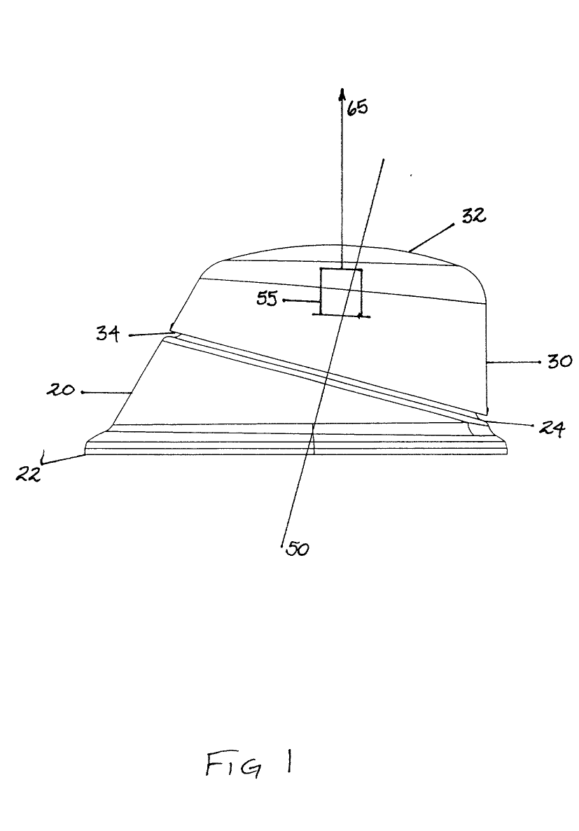

Referring to FIGS. 1 to 4, a multi-purpose security enclosure 10 of the invention is generally shown. The multi-purpose security enclosure 10 includes a mounting base 20 and a protective cover 30.

The mounting base 20 is generally cylindrical in shape having a bottom plane 22 and an engagement plane 24. The engagement plane 24 is at an acute angle to the bottom plane 22. The bottom plane 22 contacts the surface to which the multi-purpose security enclosure 10 is to be mounted.

The mounting base 20 may be mounted to a ceiling, wall or any other location where a security device is to be located. The mounting base 20 may be mounted by any means sufficient to secure the mounting base 20 in a particular location.

Similarly, the protective cover 30 is generally cylindrical in shape having a closed top portion 32 and an engagement plane 34. The engagement plane 34 of the protective cover 30 contacts the engagement plane 24 of the mounting base 20. The protective cover 30 is rotationally secured to the mounting base 20 allowing the protective cover to rotate through 360° about the rotational axis 50. The axis of rotation 50 of the protective cover 30 is at a 90° angle to the plane of engagement of the engagement plane 24 and engagement plane 34 of the mounting base 20 and the protective cover 30 respectively. The entire protective cover 30, or a portion thereof such as top portion 32, allows light to be received, transmitted, or both by the security device 55.

The security device 55 is mounted within the interior of the protective cover 30. In this way, the security device 55 maintains a fixed positional relationship with respect to the top portion 32 of the protective cover 30.

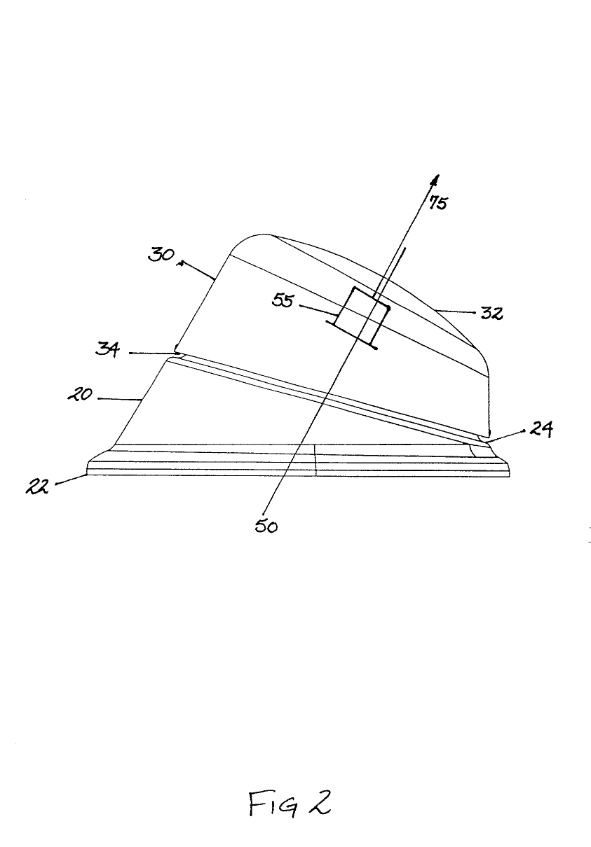

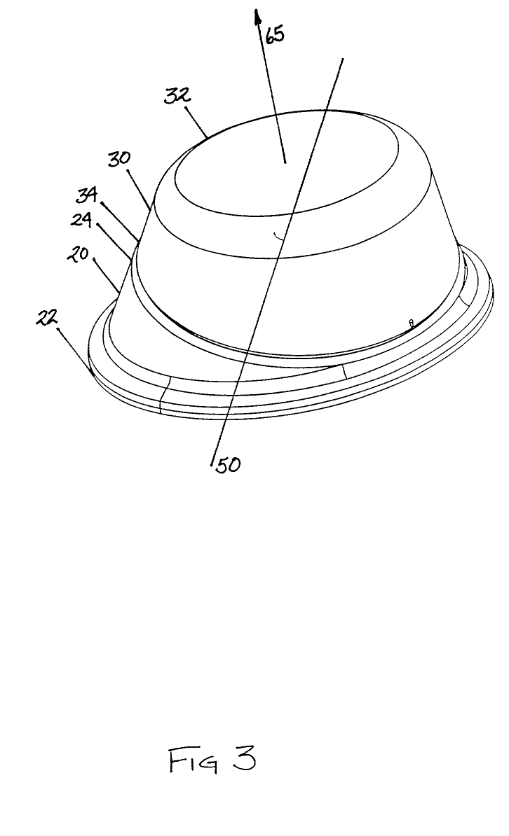

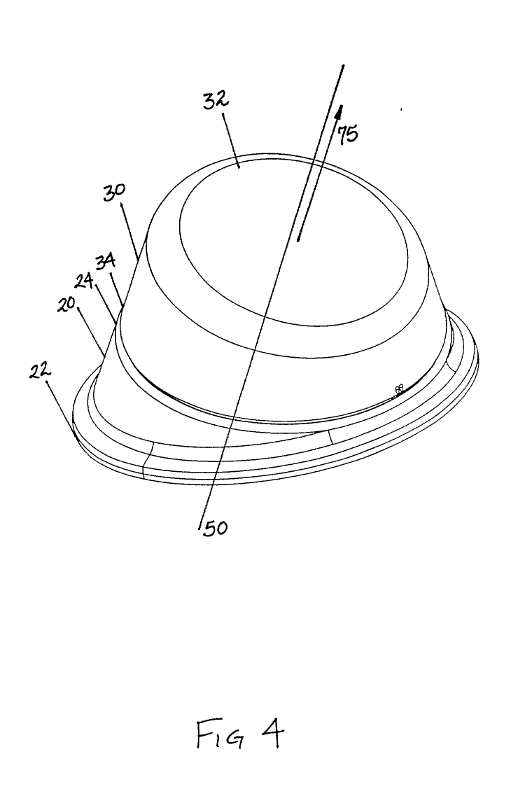

Referring to FIGS. 1 to 4, the rotational, angular engagement of the mounting base 20 and the protective cover 30 allows a security device 55 to be positioned from a direction of view 65 that is perpendicular to the bottom plane 22 of the mounting base (as shown in FIGS. 1 and 3) to a direction of view 75 that is parallel to the rotational axis 50 of the protective cover 30 (as shown in FIGS. 2 and 4).

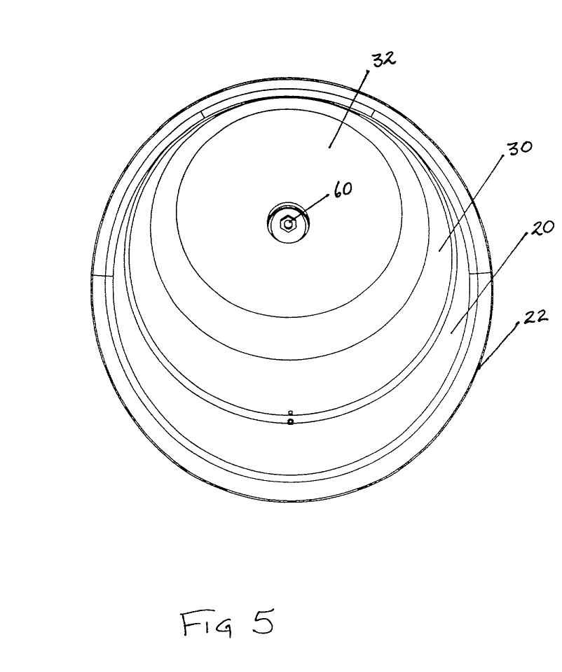

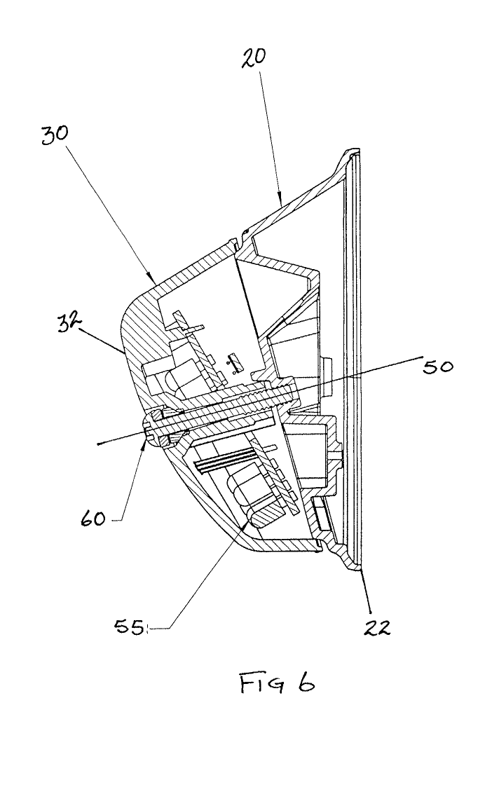

Referring to FIGS. 5 and 6, a multi-purpose security enclosure 10 is shown having an axial fastener 60 as a securement means. The axial fastener 60 passes through the top portion 32 of the protective cover 30 and is secured to the mounting base 20. The axial fastener 60 lies along the rotational axis 50 of the protective cover 30.

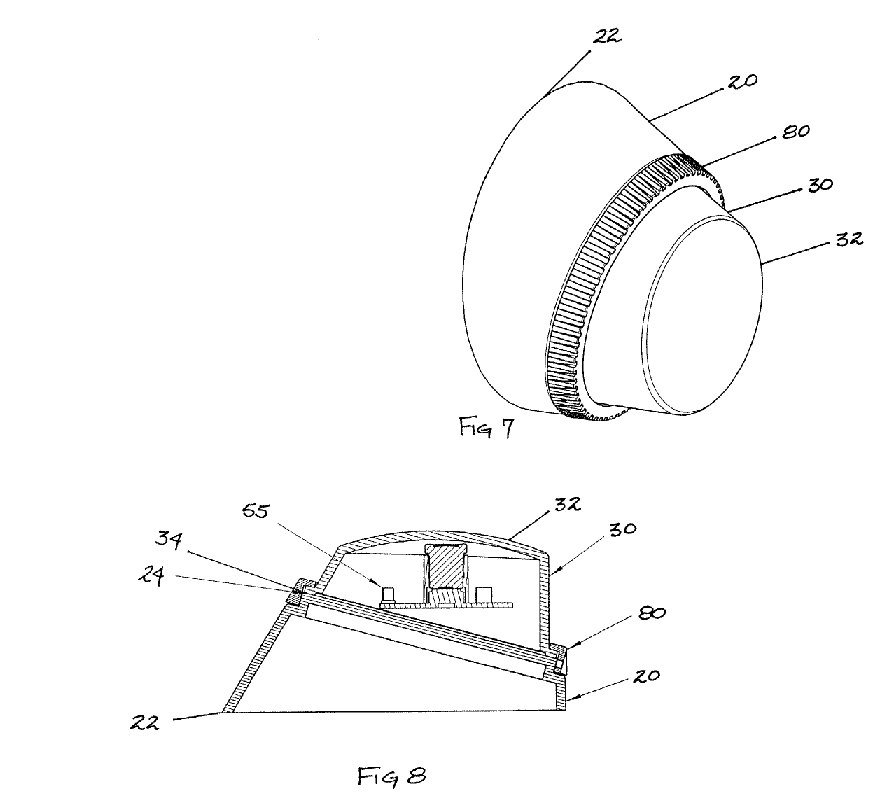

Referring to FIGS. 7 and 8, a multi-purpose security enclosure 10 is shown having a perimeter bracket 80 as a securement means. The perimeter bracket 80 engages the protective cover 30 and the mounting base 20 around the perimeter where the engagement plane 24 contacts the engagement plane 34.

Any securement means may be used such that contact is maintained between the engagement plane 24 of the mounting base 20 and the engagement plane 34 of the protective cover 30, and the protective cover 30 is allowed to rotate 360°.

It will be understood by those skilled in the art that the angle between the plane of engagement of the protective cover and the mounting base, and the bottom plane can be varied to suit specific applications. Furthermore, it will be understood that the depth of both the protective cover and the mounting base may be varied to accommodate security devices of differing sizes and shapes.

It will be appreciated by those skilled in the art that the multi-purpose security enclosure of this invention is distinguished by its versatility, simplicity, and efficiency. Moreover, the design of the multi-purpose security enclosure precludes the need for enclosures of having various fixed directions of view.

Although the present invention has been described in detail with reference to one preferred embodiment, it will be clearly understood that this is by way of illustration only. Many variations and alternative embodiments of the invention will now be apparent to those skilled in the art, and are not to be excluded from the scope of the invention, which is to be determined only by the appended claims, as set forth below.

What is claimed is:

1. A multi-purpose security enclosure comprising:
(a) a mounting base;
(b) a protective cover; and
(c) a securement means;
wherein said protective cover is rotationally, angularly secured to said mounting base by said securement means such that a plane of engagement between said mounting base and said protective cover is at an acute angle to a bottom plane of said mounting base.

2. The multi-purpose security enclosure according to claim 1, wherein said protective cover allows light to be transmitted from an interior of said protective cover.

3. The multi-purpose security enclosure according to claim 1, wherein said protective cover allows light to be received into an interior of said protective cover.

4. The multi-purpose security enclosure according to claim 1, wherein said securement means is an axial fastener that passes through a top portion of said protective cover to engage said mounting base.

5. The multi-purpose security enclosure according to claim 1, wherein said securement means is a perimeter bracket engaging said protective cover and said mounting bracket around the perimeter of said plane of engagement.

6. The multi-purpose security enclosure according to claim 1, wherein said protective cover is rotatable through 360°.

7. The multi-purpose security enclosure according to claim 1, wherein a security device is secured within the interior of said protective cover.
